(19) United States
(12) Patent Application Publication
(10) Pub. No.: US 2025/0272560 A1
(43) Pub. Date: Aug. 28, 2025

(54) METHOD AND APPARATUS FOR IMPROVING EFFECTIVE PRECISION OF NEURAL NETWORK THROUGH ARCHITECTURE EXTENSION

(71) Applicant: SAPEON KOREA INC., Seongnam-si, Gyeonggi-do (KR)

(72) Inventor: Yong Seok CHOI, Seoul (KR)

(21) Appl. No.: 18/690,300

(22) PCT Filed: Sep. 6, 2022
(86) PCT No.: PCT/KR2022/013335

§ 371 Date: Sep. 3, 2024

(30) Foreign Application Priority Data
Sep. 15, 2021 (KR) 10-2021-0123351

(51) Int. Cl. G06N 3/082

(52) U.S. Cl. CPC G06N 3/082

(57) ABSTRACT

A method and apparatus for improving effective precision of neural network through architecture extension are disclosed. According to one aspect of the present invention, a computer-implemented method for expanding an architecture of a neural network is provided, the method comprising selecting a target producer neuron from neurons included in the neural network, the target producer neuron outputting an activation clipped according to a given clipping range; dividing the given clipping range into a plurality of segments; replacing the target producer neuron with a plurality of producer neurons corresponding to the segments; setting parameters of each producer neuron such that each producer neuron processes an input of the target producer neuron; and setting parameters of a consumer neuron connected to the target producer neuron such that the consumer neuron processes outputs of the plurality of producer neurons.

### TECHNICAL FIELD

Embodiments of the present disclosure relate to a method and apparatus for improving the effective precision of a neural network, and more specifically, to a method and apparatus for improving the effective precision of a neural network by expanding the architecture of the neural network.

### BACKGROUND ART

The content described in this section simply provides background information about the present disclosure and does not constitute prior art.

A neural network is a machine learning model created by imitating the structure of human neurons. A neural network is composed of one or more layers, and output data of each layer is used as input to the next layer. Recently, research has been intensively conducted on utilization of a deep neural network composed of multiple layers, and deep neural networks play an important role in increasing recognition performance in various fields such as speech recognition, natural language processing, and lesion diagnosis.

In the architecture of a neural network, the neural network is composed of one or more layers, and each layer includes artificial neurons. Artificial neurons in one layer are connected to artificial neurons in other layers through weights. Artificial neurons process data received through weights from outputs of artificial neurons of previous layers and transmit the processed data to other artificial neurons. Artificial neurons can further apply a bias to received data through weights. As a neural network is trained based on a given training data set, weights and biases are determined. That is, the trained neural network has valid weights and biases. Thereafter, the trained neural network performs a task for a given input using the determined weights and biases.

Generally, weights and biases in a trained neural network have fixed values. Additionally, the weights and biases have fixed precision. For example, if a neural network is trained in 32-bit floating-point numbers (FP32), weights and biases are represented in 32-bit floating-point numbers.

However, if weights and biases have fixed precision, it is difficult for each artificial neuron to perform operations that require higher precision than the fixed precision.

Specifically, when artificial neurons perform an operation of limiting an output range using a clipping function, the artificial neurons may output clipped activations according to a given clipping range. Although an activation within the clipping range is output as it is, an activation outside the clipping range is output after being saturated or clipped to a boundary value of the clipping range. Here, a clipped activation is represented with fixed precision. If the fixed precision is low precision, a clipped activation is also represented with low precision. Even if some activations are calculated with high precision and the precision of the neural network can be improved, the precision of the neural network relatively deteriorates because the activations have fixed precision after training of the neural network is completed.

Therefore, research is required to enable some artificial neurons to perform operation with higher precision than fixed precision even if the precision of artificial neurons in a neural network is fixed.

### DISCLOSURE

### Technical Problem

A main object of embodiments of the present disclosure is to provide a method and apparatus for improving the effective precision of neurons by replacing a target neuron in a neural network with a plurality of neurons and setting parameters of the replaced neurons.

An object of other embodiments of the present disclosure is to provide a method and apparatus for improving the effective precision of neurons by allowing replaced neurons to perform clipping according to a range of segments divided from a clipping range provided to a target neuron to calculate activations with high precision within the provided clipping range.

An object of other embodiments of the present disclosure is to provide a method and apparatus for improving the effective precision of neurons by allowing replaced neuron to clip activations within a wider range than a clipping range provided to a target neuron.

### Technical Solution

According to one aspect of the present disclosure, a computer-implemented method for expanding an architecture of a neural network is provided, the method comprising selecting a target producer neuron from neurons included in the neural network, the target producer neuron outputting an activation clipped according to a given clipping range; dividing the given clipping range into a plurality of segments; replacing the target producer neuron with a plurality of producer neurons corresponding to the segments; setting parameters of each producer neuron such that each producer neuron processes an input of the target producer neuron; and setting parameters of a consumer neuron connected to the target producer neuron such that the consumer neuron processes outputs of the plurality of producer neurons.

According to other aspect of the present disclosure, a computing device is provided, the computing device comprising a memory in which instructions are stored; and at least one processor, wherein the at least one processor is configured to, by executing the instructions: select a target producer neuron from the neurons included in a neural network, the target producer neuron outputting an activation clipped according to a given clipping range; divide the given clipping range into a plurality of segments; replace the target producer neuron with a plurality of producer neurons corresponding to the segments; set parameters of each producer neuron such that each producer neuron processes an input of the target producer neuron; and set parameters of a consumer neuron connected to the target producer neuron such that the consumer neuron processes outputs of the plurality of producer neurons.

According to other aspect of the present disclosure, a computer-readable recording medium storing instructions is provided, the instructions causing a computer, when executed by the computer, to execute processes of selecting a target producer neuron from neurons included in the neural network, the target producer neuron outputting an activation clipped according to a given clipping range; dividing the given clipping range into a plurality of segments; replacing the target producer neuron with a plurality of producer neurons corresponding to the segments; setting parameters of each producer neuron such that each producer neuron processes an input of the target producer neuron; and setting parameters of a consumer neuron connected to the target producer neuron such that the consumer neuron processes outputs of the plurality of producer neurons.

### Advantageous Effect

As described above, according to an embodiment of the present disclosure, it is possible to improve the effective precision of neurons by replacing a target neuron in a neural network with a plurality of neurons and setting parameters of the replaced neurons.

According to other embodiments of the present disclosure, it is possible to improve the effective precision of neurons by allowing replaced neurons to perform clipping according to a range of segments divided from a clipping range provided to a target neuron to calculate activations with high precision within the provided clipping range.

According to other embodiments of the present disclosure, it is possible to improve the effective precision of neurons by allowing replaced neuron to clip activations within a wider range than a clipping range provided to a target neuron.

### BRIEF DESCRIPTION OF THE DRAWING

FIG. 1A is a diagram showing the computation structure of a neural network.

FIG. 1B is a diagram showing a clipping function.

FIG. 2 is a diagram showing architectural expansion of a neural network according to an embodiment of the present disclosure.

FIG. 3 is a diagram showing a target producer neuron and a consumer neuron according to an embodiment of the present disclosure.

FIG. 4 is a diagram showing division of a clipping range according to an embodiment of the present disclosure.

FIG. 5A is a diagram showing an expanded architecture of a neural network according to an embodiment of the present disclosure.

FIG. 5B is a diagram showing clipping ranges corresponding to a plurality of producer neurons.

FIG. 6A is a diagram showing an expanded architecture of a neural network according to an embodiment of the present disclosure.

FIG. 6B is a diagram showing clipping ranges corresponding to a plurality of producer neurons.

FIG. 7 is a diagram showing an expanded architecture of a neural network according to an embodiment of the present disclosure.

FIG. 8A is a diagram showing an architecture expanded to have an expanded clipping range according to an embodiment of the present disclosure.

FIG. 8B is a diagram showing an architecture expanded to have high effective precision according to an embodiment of the present disclosure.

FIG. 9 is a flowchart of a method of expanding the architecture of a neural network according to an embodiment of the present disclosure.

FIG. 10 is a configuration diagram of an electronic device according to an embodiment of the present disclosure.

### DETAILED DESCRIPTION

Hereinafter, some embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

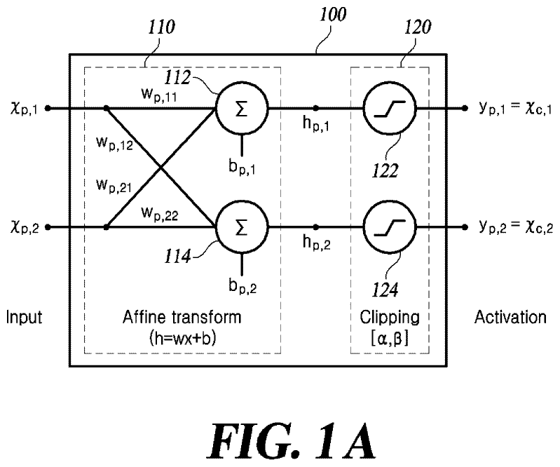

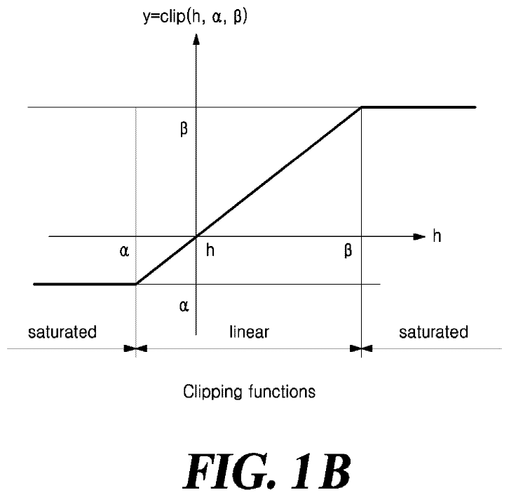

FIG. 1A is a diagram showing the computation structure of a neural network.

Referring to FIG. 1A, a layer 100, an affine transform block 110, and a clipping block 120 are shown.

The layer 100 represents at least one layer included in the neural network. In a case where the neural network includes a plurality of layers, each layer receives the output of another layer as input and transmits the output thereof to another layer. Hereinafter, description will be made on the assumption that other layers are present before and after the layer 100.

The layer 100 receives inputs x_{p,1} and x_{p,2} from the previous layer. The layer 100 processes the inputs x_{p,1} and x_{p,2} and outputs activations y_{p,1} and y_{p,2}. The inputs x_{p,1} and x_{p,2} of the layer 100 are outputs of the previous layer.

Each layer included in the neural network includes at least one neuron. In FIG. 1A, the layer 100 includes a first neuron located at the top and a second neuron located at the bottom. The first neuron includes first weights w_{p,11} and w_{p,12} and a first bias b_{p,1}. The second neuron includes second weights w_{p,21} and w_{p,22} and a second bias b_{p,2}.

Each neuron processes inputs based on the weights and bias to calculate a biased weighted sum. For example, the first neuron calculates the weighted sum of the inputs x_{p,1} and x_{p,2} and the first weights w_{p,11} and w_{p,12} and applies the first bias b_{p,1} to the weighted sum to calculate a first biased weighted sum h_{p,1}. This is called affine transformation.

Each neuron is given a clipping range and can perform clipping on a biased weighted sum. A clipping range is a previously given value. A clipping range can be determined along with parameters of a neural network when training of the neural network is completed. A clipping range may be determined based on activation values in the inference step. In addition, a clipping range can be set by a user. In FIG. 1A, the first neuron has α and β as boundary values of a clipping range. The first neuron calculates a first activation y_{p,1} by clipping the first biased weighted sum h_{p,1} according to the clipping range.

FIG. 1B is a diagram showing a clipping function.

Referring to FIG. 1B, the clipping function clips a biased weighted sum h according to a clipping range [α,β]. The clipping function outputs an input within the clipping range as it is and outputs an input outside the clipping range as a boundary value of the clipping range. That is, the clipping function is represented as a linear function within the clipping range.

If the input of the clipping function is a value within the clipping range [α,β], the input of the clipping function is output as it is. On the other hand, if the input of the clipping function has a value smaller than α, the output of the clipping function is α. If the input of the clipping function has a value greater than β, the output of the clipping function is β.

According to an embodiment of the present disclosure, a clipping function and an activation function may be used together in the clipping block 120. Here, in order to apply the embodiment of the present disclosure, the activation function must not affect the output of the clipping function.

Specifically, a biased weighted sum is first input to the activation function, and the output of the activation function may be clipped according to the clipping range and then output as an activation. For a biased weighted sum h, the activation function can be represented as y=f(h) and the clipping function can be represented as y=clip(h, α, β) using formulas. In a case where both the activation function and the clipping function are applied to the biased weighted sum, the clipping function can use the output of the activation function as an input. Here, the output of the clipping function can be represented as y=clip(f(h), α, β).

According to an embodiment of the present disclosure, the output of the clipping function that receives the output of the activation function for the biased weighted sum as an input is the same as the output of the clipping function for the biased weighted sum. For example, when the activation function is a rectified linear unit (ReLu) function and a of the clipping range has a value equal to or greater than 0, clip(ReLu(h), α, β)=clip(h, α, β) is established. That is, whether or not the input passes through the activation function does not affect the output of the clipping function. In this manner, when the output value of the clipping function having the output of the activation function for the biased weighted sum as an input is the same as the output of the clipping function for the biased weighted sum, an architecture expansion method according to an embodiment of the present disclosure can be applied.

Referring to FIGS. 1A and 1, a clipping range is given, and each neuron performs clipping according to the given clipping range and outputs activations with fixed precision. Activations output from the same layer have single precision.

In other words, activations are represented with a given clipping range and represented with fixed precision even within the clipping range.

When activations output from some neurons need to be represented with high precision, if the activations are represented with fixed precision, the performance of the neural network may not be fully demonstrated. Additionally, even when activations need to be clipped in a wider range than the given clipping range, if the activations are clipped within the given clipping range, the performance of the neural network may not be fully utilized.

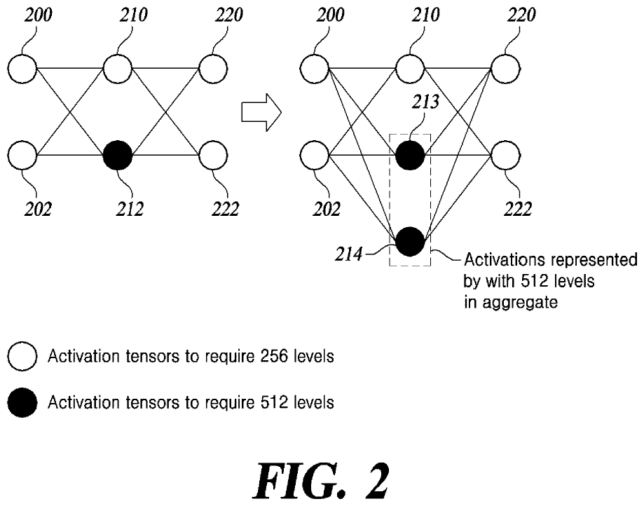

FIG. 2 is a diagram showing architectural expansion of a neural network according to an embodiment of the present disclosure.

Referring to FIG. 2, the neural network includes a plurality of neurons 200, 202, 210, 212, 220, and 222. Specifically, the neural network includes three layers which are connected by branches. The first layer includes first neurons 200 and 202, the second layer includes second neurons 210 and 212, and the third layer includes consumer neurons 220 and 222.

The neural network has fixed parameters after trained, and an activation output from each neuron has fixed precision. For example, in FIG. 2, the plurality of neurons 200, 202, 210, 212, 220, and 222 output activations of 256 levels. That is, the activation output from each neuron has a precision of 256 levels. Additionally, the activation output from each neuron has a value within a given clipping range.

Here, if some activations are represented with high precision within the given clipping range, the performance of the neural network can be improved. In FIG. 2, the output activation of the target neuron 212 has a precision of 256 levels within the given clipping range, but needs to be output with a precision of 512 levels in order to improve the precision of the neural network.

In addition, the performance of the neural network can be improved in a case where some activations have the same resolution and are represented in a wider range than the given clipping range. Although the output activation of the target neuron 212 has a value within the given clipping range in FIG. 2, the output activation needs to be clipped according to a wider clipping range in order to improve the precision of the neural network.

According to an embodiment of the present disclosure, the architecture of the neural network can be expanded in order to improve the precision of activations output from some neurons. The architecture of the neural network can be expanded by replacing a neuron that requires high precision or a wide clipping range with a plurality of neurons. In FIG. 2, the target neuron 212 is replaced with a first producer neuron 213 and a second producer neuron 214.

Here, the first producer neuron 213 and the second producer neuron 314 have independent clipping ranges. The first producer neuron 213 and the second producer neuron 314 output activations with a precision of 256 levels.

If the sum of the clipping range of the first producer neuron 213 and the clipping range of the second producer neuron 214 is the same as the clipping range of the target neuron 212, the same effect as improvement of the effective precision of the output activation of the target neuron 212 due to architecture expansion is obtained. While the output activation of the first target neuron 212 has a precision of 256 levels within the clipping range, the output activations of the replaced neurons 213 and 214 can represent a precision of 512 levels within the same clipping range. That is, the consumer neurons 220 and 222 connected to both the first producer neuron 213 and the second producer neuron 314 can be considered to receive activations with higher precision than the output activation of the target neuron 212. The consumer neurons 220 and 222 receive the same input as the activation with a precision of 512 levels from the target neuron 212. That is, the resolution of input activations of the consumer neurons 220 and 222 increases.

Meanwhile, in a case where the sum of the clipping range of the first producer neuron 213 and the clipping range of the second producer neuron 214 is greater than the clipping range of the target neuron 212, the same effect as improvement of the effective precision of the output activation of the target neuron 212 due to architecture expansion is obtained. The first producer neuron 213 clips activations in the same range as the clipping range of the target neuron 212, and the second producer neuron 214 clips activations in a range outside the clipping range of the target neuron 212. The output activation of the target neuron 212 has a value within the given clipping range, whereas the output activations of the replaced neurons 213 and 214 may exhibit values in a range wider than the given clipping range. The consumer neurons 220 and 222 operate as if they receive activations having values in a wider range than the given clipping range from the target neuron 212.

In this manner, in a situation in which the precision of the output of each layer is fixed and the clipping range is determined, the neural network can improve the effective precision of the output of each layer.

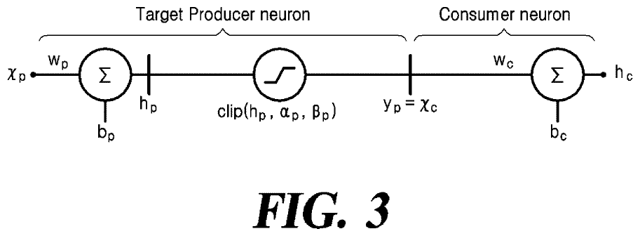

FIG. 3 is a diagram showing a target producer neuron and a consumer neuron according to an embodiment of the present disclosure.

Referring to FIG. 3, a target producer neuron and a consumer neuron are shown. The target producer neuron and the consumer neuron are included in different layers.

A target producer neuron refers to a neuron that requires an increase in the effective precision of output activation in order to improve the accuracy of the neural network. An activation having a value within a given clipping range and given precision is output from a target producer neuron.

A consumer neuron is a neuron that receives and processes an activation from a producer neuron.

The target producer neuron and the consumer neuron may include parameters. The target producer neuron includes a producer weight wₚ and a producer bias bₚ. The consumer neuron includes a consumer weight w_{c} and a consumer bias b_{c}.

The target producer neuron can calculate a biased weighted sum hₚ by multiplying an input xₚ by the producer weight wₚ and then adding the producer bias bₚ to the result. The target producer neuron can output a clipped activation yₚ by clipping the biased weighted sum hₚ according to a given clipping range. The clipped activation yₚ serves as an input x_{c} of the consumer neuron. Although there are one input of the producer neuron and one input of the consumer neuron in the following description, this is merely an example and there may be multiple inputs of the producer neuron and multiple inputs of the consumer neuron. That is, the producer neuron and the consumer neuron can apply affine transformation to multiple inputs.

The target producer neuron outputs an activation clipped according to the given clipping range. The clipping range of the target producer neuron is given as [αₚ, βₚ]. The activation of the target producer neuron has a value within the clipping range and is represented with fixed precision.

To improve the effective precision of the output activation of the target producer neuron, the target producer neuron is replaced with a plurality of producer neurons.

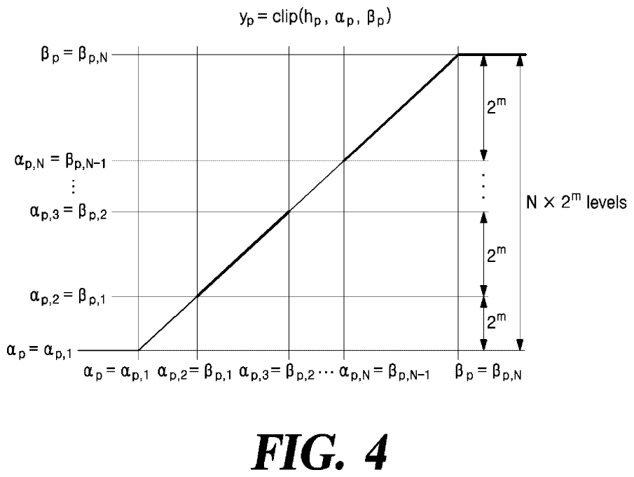

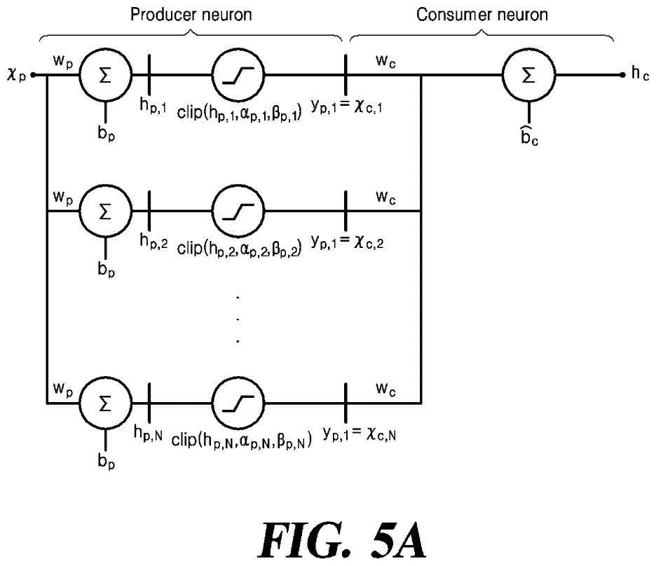

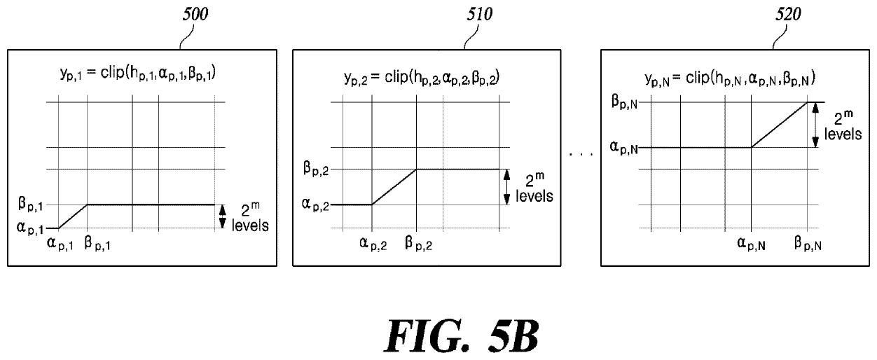

FIG. 4 is a diagram showing division of a clipping range according to an embodiment of the present disclosure. FIG. 5A is a diagram showing an expanded architecture of a neural network according to an embodiment of the present disclosure. FIG. 5B is a diagram showing clipping ranges corresponding to a plurality of producer neurons.

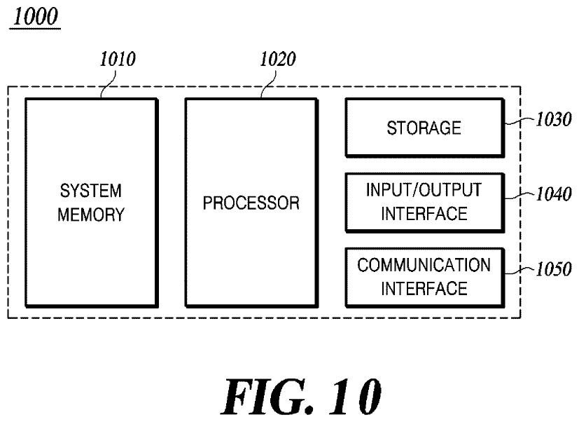

Hereinafter, operations performed to expand the architecture of a neural network will be described as being performed by an electronic device. The specific configuration of the electronic device will be described with reference to FIG. 10.

Referring to FIG. 4, a given clipping range of a clipping function and segmented segments are shown. A clipping range of a target producer neuron is given as [αₚ, βₚ].

In order to increase the effective precision of a target producer neuron, the electronic device determines the number of segments of a clipping range of the target producer neuron and a segmentation range. Based on the determined number of segments and segmentation range, the electronic device segments the clipping range of the target producer neuron into a plurality of segments. The plurality of segments may have the same size or different sizes. Additionally, at least two of the plurality of segments may have different sizes. An activation clipped according to the range of each segment has a precision of 2^{m} levels.

Referring to FIG. 5A, the electronic device replaces the target producer neuron in FIG. 3 with a plurality of producer neurons corresponding to the divided segments. The number of producer neurons is equal to the number of segments. Each producer neuron outputs an activation clipped according to the range of the corresponding segment.

Referring to FIG. 5B, clipping functions corresponding to divided segments are shown. A first clipping function 500 is a function that has the first segment as a clipping range. A second clipping function 510 is a function that has the second segment as a clipping range.

Referring to FIGS. 5A and 5B, the first clipping range of the first producer neuron is [α_{p,1}, β_{p,1}]. The first producer neuron outputs a first output activation y_{p,1} by clipping a first biased weighted sum h_{p,1} according to the first clipping range. The second clipping range of the second producer neuron is [α_{p,2}, β_{p,2}]. The second producer neuron outputs a second output activation y_{p,2} by clipping a second biased weighted sum h_{p,2} according to the second clipping range.

As the target producer neuron is replaced with a plurality of producer neurons, the electronics sets parameters of each producer neuron such that each producer neuron processes the input of the target producer neuron. Specifically, the electronics sets weights and a bias of each producer neuron.

Each producer neuron receives the same input as that of the target producer neuron and calculates biased weighted sums using set parameters. Each producer neuron clips the biased weighted sums according to the range of the corresponding segment.

Meanwhile, as the target producer neuron is replaced with a plurality of producer neurons, the electronic device sets parameters of a consumer neuron connected to the target producer neuron such that the consumer neuron processes the outputs of the plurality of producer neurons. Specifically, the consumer neuron is set such that the consumer neuron includes parameters applied to the output of each producer neuron. The consumer neuron connected to the target producer neuron is connected to each of the plurality of producers.

The consumer neuron receives output activations of each producer neuron and applies parameters to the output activations. Specifically, the consumer neuron calculates a weighted sum by applying each weight to the output activations of each producer neuron. Thereafter, the consumer neuron applies a bias to the weighted sum.

Referring to FIG. 5A, each producer neuron can process input using the same parameters as the parameters of the target producer neuron. Each producer neuron can be set such that it has the producer weight wₚ and the producer bias bₚ of the target producer neuron as a weight and a bias thereof.

The consumer neuron can process outputs of a plurality of producer neurons using the same parameters as the parameters applied to the output of the target producer and an offset according to a plurality of segments. Specifically, the consumer neuron calculates a weighted sum by applying the same weight as the consumer weight w_{c} applied to the output of the target producer neuron to the output activation of each producer neuron. The consumer neuron calculates the output of the consumer neuron by reflecting the offset according to the plurality of segments in the calculated weighted sum. The output of the consumer neuron can be represented by Formula 1.

$${h}_{c} = ( {\sum }_{i = 1}^{N} {w}_{c} {y}_{p , i} ) + ( {w}_{c} {α}_{p} + {b}_{c} - {\sum }_{i = 1}^{N} {w}_{c} {α}_{p , i} ) \qquad [ Formula 1 ]$$

In Formula 1, h_{c} is the output of the consumer neuron, N is the number of producer neurons, w_{c} is a consumer weight, y_{p,i} is the output activation of each producer neuron, αₚ is the minimum value of a given clipping range, βₚ is the maximum value of the given clipping range, b_{c} is a consumer bias, and α_{p,i} is the minimum value of a segment corresponding to each producer neuron.

According to an embodiment of the present disclosure, output activations of a plurality of producer neurons have the same precision as the output activation of the target producer neuron. Referring to FIGS. 3 and 5A, the first output activation y_{p,1}, the second output activation y_{p,2}, and the n-th output activation y_{p,n} have the same precision as that of the activation yₚ clipped by the target producer neuron. In this case, the plurality of producer neurons can improve the precision of output activations compared to the target producer neuron. If the number of neurons is n, and the output activations of the plurality of producer neurons are aggregated, the given clipping range is divided into N×2ₘ levels. Compared to the target producer neuron which divides the given clipping range into 2ₘ levels, the plurality of producer neurons can divide the given clipping range into N×2ₘ levels. This allows the consumer neuron connected to the plurality of producer neurons to process an activation with higher precision as input.

According to another embodiment of the present disclosure, the electronic device divides the clipping range given to the target producer neuron into a plurality of segments and converts the plurality of segments into segments that have the same size as the given clipping range and do not overlap. This allows the plurality of producer neurons to have a wider clipping range than the target producer neuron. For example, the electronic device converts the clipping range of the first producer neuron from [α_{p,1}, β_{p,1}] to [αₚ, βₚ] in FIG. 5A. Additionally, the electronic device converts the clipping range of the second producer neuron from [α_{p,2}, β_{p,2}] to [βₚ, βₚ+(βₚ−αₚ)]. The first producer neuron becomes the same as the target producer neuron. Instead, the second producer neuron can process values outside the given clipping range. This allows the consumer neuron connected to the plurality of producer neurons to process activations having values in a wider range as inputs.

Referring back to FIG. 4, the electronic device can quantize the neural network with an expanded architecture. Quantization is converting high-precision tensors into low-precision values. Here, a tensor means at least one of a weight, a bias, or an activation of a neural network. Quantization can reduce the computational complexity of a neural network by converting high-precision tensors into low-precision values.

According to an embodiment of the present disclosure, at least two of a plurality of segments have different sizes. In this case, when the electronic device quantizes the neural network, non-linear quantization effect occurs due to quantization.

Specifically, parameters included in the plurality of producer neurons are quantized, and output activations of the plurality of producer neurons are also quantized. When the sizes of segments corresponding to respective producer neurons are different, the output activations of the plurality of producer neurons are quantized non-linearly.

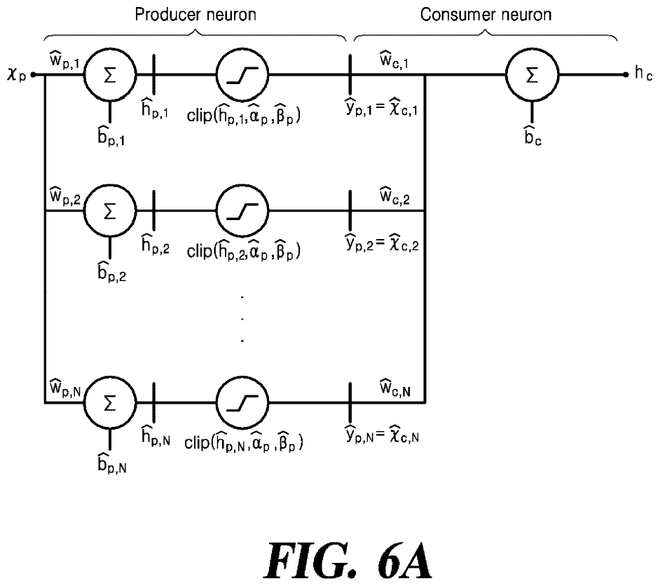

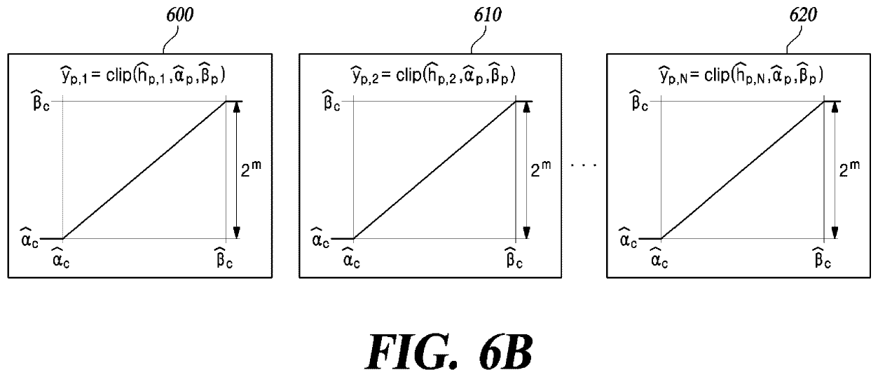

FIG. 6A is a diagram showing an expanded architecture of a neural network according to an embodiment of the present disclosure. FIG. 6B is a diagram showing clipping ranges corresponding to a plurality of producer neurons.

The electronic device that performs neural network operations calculates a clipping function of each producer neuron.

Here, due to hardware limitations, the size of a segment corresponding to each producer neuron may be different from the size of a segment that can be calculated in each producer neuron. For example, a clipping range that can be calculated by hardware may be different from a clipping range assigned to each producer neuron. Furthermore, even though different clipping ranges are assigned to neurons included in the same layer, the same clipping range may need to be set for hardware efficiency.

Therefore, it is necessary to adjust the size and range of the segment corresponding to each producer neuron.

Referring to FIG. 5A, each producer neuron includes the same parameters, and the weights of the consumer neurons are all identical. However, the plurality of producer neurons has different segment ranges.

On the other hand, referring to FIG. 6A, each producer neuron includes independent parameters, and the weights of the consumer neuron also have independent values. Instead, the plurality of producer neurons may have the same segment range.

As described above, the electronic device can set the parameters of the plurality of producer neurons and set the parameters of the consumer neuron such that segments of the producer neurons match. This is for the electronic device to perform a given operation within a segment range in which calculation can be performed even when the range of logically necessary segments is different from the range of segments that can be physically calculated by the electronic device. Even if there is a segment that cannot be calculated by the electronic device, this segment can be converted into a segment that can be calculated by setting parameters.

However, unlike FIG. 6A, according to another embodiment of the present disclosure, each producer neuron includes independent parameters, and a plurality of producer neurons may have different segment ranges. That is, the electronic device can independently determine the segment range of each producer neuron and set the parameters of each producer neuron according to the determined segment range. Here, the electronic device can adjust the range of each segment for each producer neuron. Additionally, the electronic device can independently set the weights of a consumer neuron for each producer neuron.

Referring back to FIG. 6A, the electronic device can adjust the plurality of segments such that they have the same size and set parameters of the neural network according to adjustment. Otherwise, a plurality of segments divided from the clipping range may be adjusted for each producer neuron in consideration of the operation range of each producer neuron.

Referring to FIG. 6B, clipping functions corresponding to each producer neuron are shown. According to an embodiment of the present disclosure, both the first clipping function 500 and the second clipping function 510 have segments of the same size as clipping ranges. In this manner, a plurality of segments divided from a given clipping range can be adjusted into segments having the same size. Each producer neuron outputs activation clipped according to the same clipping range. The parameters of a plurality of producer neurons and the parameters of a consumer neuron need to be set appropriately.

Referring to FIG. 6A, the electronic device can set parameters of each producer neuron based on based on the range of the segment corresponding to each producer neuron and the range of the adjusted segment. Specifically, the electronic device can set the parameters of each producer neuron using Formula 2 and Formula 3.

$${s}_{p , i} = \frac{{\hat{β}}_{p} - {\hat{α}}_{p}}{{β}_{p , i} - {α}_{p , i}} , \qquad [ Formula 2 ]$$

$${c}_{p , i} = \frac{{α}_{p , i} + {β}_{p , i}}{2} ,$$

$${\hat{c}}_{p} = \frac{{\hat{α}}_{p} + {\hat{β}}_{p}}{2}$$

$${\hat{w}}_{p , i} = {s}_{p , i} {w}_{p} \qquad [ Formula 3 ]$$

$${\hat{b}}_{p , i} = {s}_{p , i} {β}_{p} - {s}_{p , i} {c}_{p , i} + {\hat{c}}_{p}$$

In Formula 2, p indicates a producer neuron, i indicates an index of each producer neuron, α_{p,i} represents the minimum value of the range of the segment corresponding to each producer neuron, β_{p,i}, represents the maximum value of the range of the segment corresponding to the producer neuron, \hat{α}ₚ represents the minimum value of the range of the adjusted segment, \hat{β}ₚ represents the maximum value of the range of the adjusted segment, s_{p,i} represents the ratio between the range of the segment corresponding to each producer neuron and the range of the adjusted segment, c_{p,i} represents the center of the segment corresponding to each producer neuron, and ĉ_{P} represents the center of the adjusted segment.

In Formula 3, ŵ_{p,i} represents the weight of each producer neuron, \hat{b}_{p,i} represents the bias of each producer neuron, wₚ represents the weight of a target producer neuron, and βₚ represents the bias of the target producer neuron.

Meanwhile, the electronic device may set the parameters of the consumer neuron based on the range of the segment corresponding to each producer neuron and the range of the adjusted segment. Specifically, the electronic device can set the parameters of each producer neuron using Formula 2 and Formula 4.

$${\hat{w}}_{c , i} = \frac{{w}_{c}}{{s}_{p , i}} \qquad [ Formula 4 ]$$

$${\hat{b}}_{c , i} = {\sum }_{i = 1}^{N} ( \frac{- {\hat{c}}_{p}}{{s}_{p , i}} + {c}_{p , i} - {α}_{p , i} ) + {w}_{c} {α}_{p} + {β}_{c}$$

In Formula 4, ŵ_{c,i} represents the weight of a consumer neuron connected to each producer neuron, w_{c} represents the weight of the consumer neuron connected to the target producer neuron, \hat{b}_{c,i} represents the bias of the consumer neuron connected to each producer neuron, β_{c} represents the bias of the consumer neuron connected to the target producer neuron, and N represents the number of multiple producer neurons.

The electronic device determines the parameters of the plurality of producer neurons by adjusting the parameters of the target producer neurons using Formula 2, Formula 3, and Formula 4. Additionally, the electronic device determines the parameters of the consumer neuron connected to the plurality of producer neurons by adjusting the parameters of the consumer neuron connected to the target producer neuron.

The electronic device can make the clipping ranges of producer neurons identical by setting the parameters of each producer neuron and the parameters of the consumer neuron using Formula 2, Formula 3, and Formula 4.

According to another embodiment of the present disclosure, the electronic device can adjust the clipping range of each producer neuron by setting the parameters of each producer neuron and the parameters of the consumer neuron using Formula 2, Formula 3, and Formula 4.

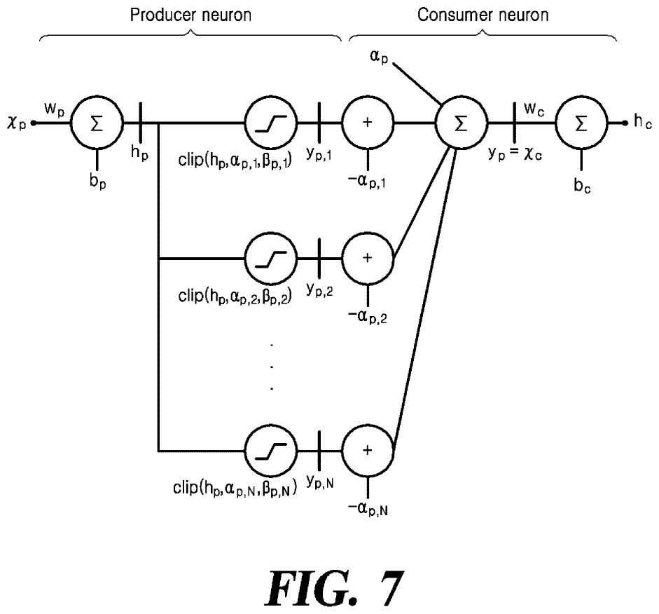

FIG. 7 is a diagram showing an expanded architecture of a neural network according to an embodiment of the present disclosure.

FIG. 7 shows that a producer neuron maintains parameters wₚ and bₚ of a target producer neuron, and only a clipping function is segmented. A consumer neuron may apply offsets αₚ, α_{p,1}, α_{p,2} and α_{p,N} to output activations y_{p,1}, y_{p.2} and y_{p,N} of the producer neuron and apply a weights w_{c} and a bias b_{c} to the application result yₚ to output an output activation h_{c} of the consumer neuron.

According to the neural network architecture shown in FIG. 7, the electronic device does not segment the target producer neuron into a plurality of producer neurons, but segments the clipping function of the target producer neuron. Additionally, the electronic device sets parameters such that the consumer neuron receives a plurality of clipping function values and applies offsets to the clipping function values.

A neuron from which the clipping function of the target producer neuron is segmented is called a producer neuron. The producer neuron receives the same input as the input xₚ of the target producer neuron, and performs the same transformation as the affine transformation of the target producer neuron. The producer neuron applies a plurality of clipping functions to the affine transformation result. The plurality of clipping functions has different clipping ranges. The producer neuron outputs a plurality of clipping results as output activations y_{p,1}, y_{p,2} and y_{p,N}.

The consumer neuron receives the output activations y_{p,1}, y_{p,2} and y_{p,N} and applies offsets αₚ, α_{p,1}, α_{p,2} and α_{p,N} to the output activations. Additionally, the consumer neuron also applies a global offset αₚ. The consumer neuron outputs the output activation h_{c} of the consumer neuron by applying the weight w_{c} and the bias b_{c} to the application result yₚ.

The offset application result yₚ of the consumer neuron can be represented by Formula 5.

$${y}_{p} = {α}_{p} + {\sum }_{i = 1}^{N} ( {y}_{p , i} - {α}_{p , i} ) \qquad [ Formula 5 ]$$

In Formula 5, i indicates an index of the clipping function and N indicates the number of segmented clipping functions. yₚ represents the offset application result of the consumer neuron, αₚ represents the global offset, y_{p,i} represents each clipping result, and α_{p,i} represents offsets applied to each output activation.

The neural network architecture shown in FIG. 7 has high efficiency when implemented such that only the clipping range of the producer neuron can be segmented at the hardware level and the consumer neuron can apply an offset to each of the output activations of the producer neuron.

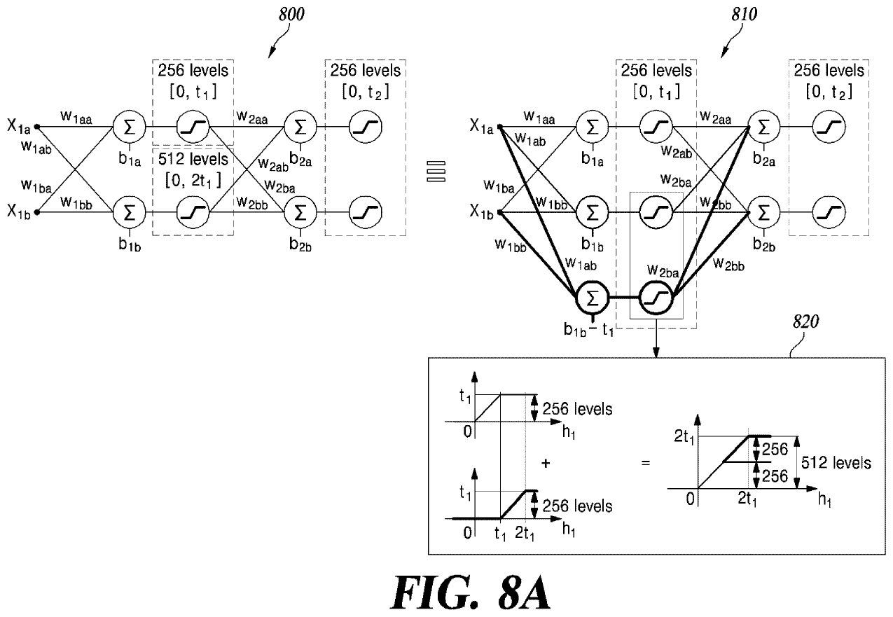

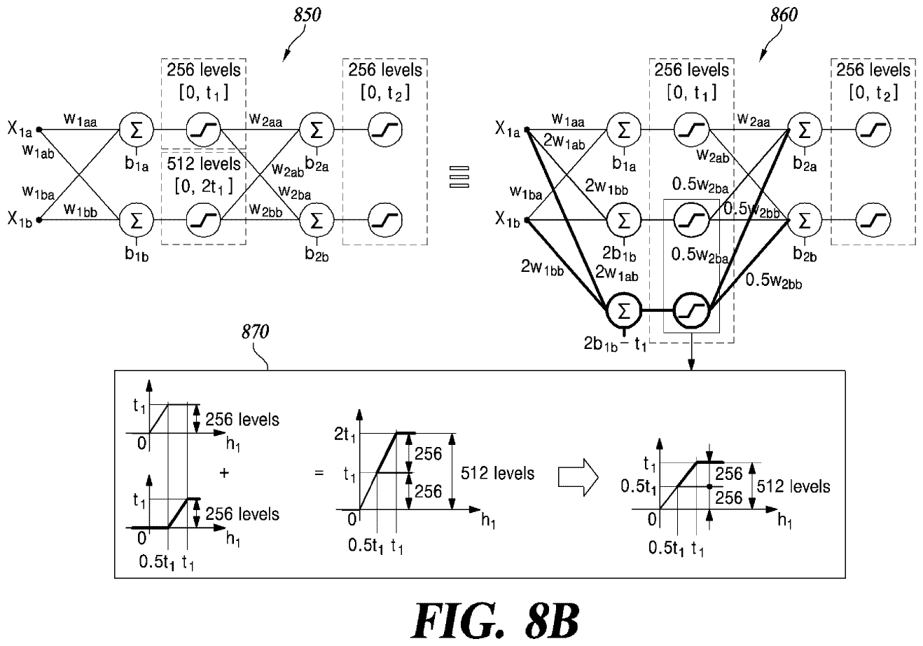

FIG. 8A is a diagram showing an architecture expanded to have an expanded clipping range according to an embodiment of the present disclosure.

Referring to FIG. 8A, an existing neural network 800 whose architecture is not expanded, a neural network 810 whose architecture has been expanded, and clipping functions 820 of replaced neurons are shown.

The existing neural network 800 can be quantized such that activations output from neurons included in the existing neural network 800 have a precision of 256 levels. When the existing neural network 800 is quantized, neurons included in the same layer output activations clipped according to the same clipping range, and output the clipped activations with a precision of 256 levels. In the existing neural network 800, neurons included in some layers have [0, t₁] as a clipping range, and neurons included in other layers have [0, t₂] as a clipping range.

However, in the existing neural network 800, some neuron can improve the accuracy of the neural network by clipping activations using a wider range than the given clipping range. That is, in order to improve the performance of the existing neural network 800, a target producer neuron at the bottom left of the existing neural network 800 has [0, 2t₁] as a clipping range and is required to calculate activations within the clipping range with 512 levels.

According to an embodiment of the present disclosure, the electronic device can improve the effective precision of the target neuron by replacing the target neuron included in the existing neural network 800 with a plurality of neurons.

The extended neural network 810 is a neural network in which the target producer neuron from the existing neural network 800 is replaced with two producer neurons. In the expanded neural network 810, a plurality of producer neurons is shown at the bottom left.

The plurality of producer neurons receives the same input as the input of the target producer neuron. Among the plurality of producer neurons, the first producer neuron has a clipping range of [0, t₁], and the second producer neuron has a clipping range of [t₁, 2t₁]. However, when the clipping functions of the plurality of producer neurons are calculated within the same range by hardware, the clipping ranges corresponding to the plurality of producer neurons may be adjusted such that they have the same size and range. The clipping function of each producer neuron has a clipping range having a size of t₁. Instead, producer neurons have different parameters. For example, the bias b_{1b} of the first producer neuron is different from the bias b_{1b}-t₁ of the second producer neuron.

Consumer neurons receive and process output activations from the plurality of producer neurons. From the perspective of the consumer neuron, receiving output activations from the plurality of producer neurons is equivalent to receiving activations clipped with a precision of 512 levels according to a clipping range of [0, 2t₁] from the target producer neuron.

Accordingly, the electronic device can substantially increase the clipping range or quantization range of neurons by replacing a neuron that requires an increase in the clipping range or quantization range with a plurality of neurons in the existing neural network 800.

FIG. 8B is a diagram showing an architecture expanded to have high effective precision according to an embodiment of the present disclosure.

Referring to FIG. 8B, an existing neural network 850 whose architecture has not been expanded, a neural network 860 whose architecture has been expanded, and clipping functions 870 of replaced neurons are shown.

The existing neural network 850 can be quantized such that activations output from neurons included in the existing neural network 850 have a precision of 256 levels. When the existing neural network 850 is quantized, neurons included in the same layer output activations clipped according to the same clipping range, and output the clipped activations with a precision of 256 levels.

However, in the existing neural network 850, some neurons output activations with higher precision than the given precision, thereby improving the accuracy of the neural network. That is, in order to improve the performance of the existing neural network 850, a target producer neuron at the bottom left of the existing neural network 850 outputs activation with a precision of 256 levels, but is required to calculate the activation with a precision of 512 levels.

According to an embodiment of the present disclosure, the electronic device can improve the effective precision of the target neuron by replacing the target neuron included in the existing neural network 850 with a plurality of neurons.

The extended neural network 860 is a neural network in which the target producer neuron from the existing neural network 850 is replaced with two producer neurons. In the expanded neural network 860, a plurality of producer neurons is shown at the bottom left.

The plurality of producer neurons receives the same input as the input of the target producer neuron. The plurality of producer neurons calculates activations with a precision of 256 levels. However, the target producer neuron calculates activations with a precision of 256 levels within the clipping range of [0, t₁]. Among the plurality of producer neurons, the first producer neuron calculates activations with a precision of 256 levels within the clipping range of [0, 0.5t₁], and the second producer neuron calculates activations with a precision of 256 levels within the clipping range of [0.5t₁, t₁].

Consumer neurons receive and process output activations from the plurality of producer neurons. From the perspective of the consumer neuron, receiving output activations from the plurality of producer neurons is equivalent to receiving activation clipped with a precision of 512 levels within the clipping range of [0, t₁] from the target producer neuron.

Accordingly, the electronic device can substantially increase the clipping range or quantization range of neurons by replacing a neuron that requires increased activation precision within a given clipping range in the existing neural network 850 with a plurality of neurons.

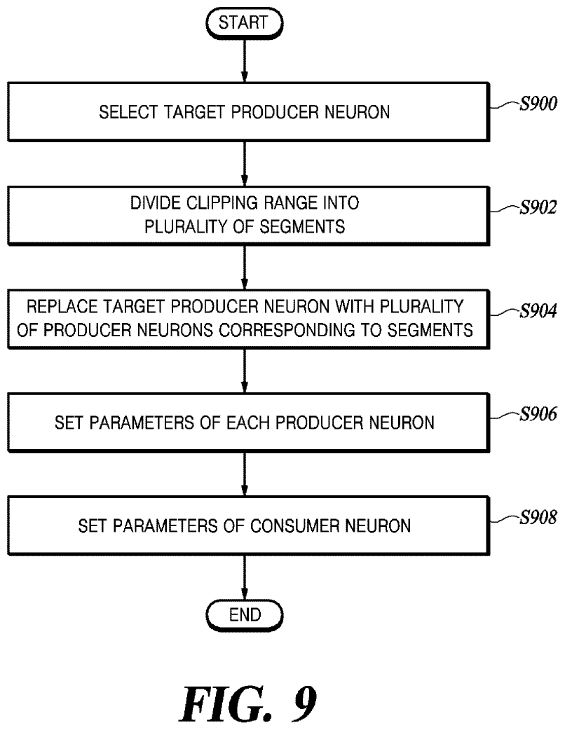

FIG. 9 is a flowchart of a method of expanding the architecture of a neural network according to an embodiment of the present disclosure.

Referring to FIG. 9, the electronic device selects a target producer neuron among neurons included in the neural network (S900).

Here, the neural network may be a trained neural network.

The target producer neuron receives input from neurons in the previous layer. The target producer neuron performs an affine transformation on the input and clips the affine transformation result according to a given clipping range. The target producer neuron outputs clipped activation.

The electronic device divides the given clipping range into a plurality of segments (S902).

At least two of the plurality of segments may have different sizes. Otherwise, the plurality of segments may have different boundary values but the same size.

The electronic device replaces the target producer neuron with a plurality of producer neurons corresponding to the segments (S904).

Each producer neuron outputs clipped activation according to the range of the corresponding segment among the plurality of segments.

According to an embodiment of the present disclosure, the plurality of output activations output by the plurality of producer neurons has the same precision as that of clipped activations output by the target producer neuron. Accordingly, the plurality of producer neurons can exhibit activations with higher precision within the same range as the clipping range of the target producer neuron.

According to an embodiment of the present disclosure, the electronic device can convert the plurality of segments into segments that have the same size as a given clipping range and do not overlap. Accordingly, the plurality of producer neurons can exhibit activations in a wider range than the clipping range of the target producer neuron.

According to another embodiment of the present disclosure, the electronic device can adjust or convert the range of each segment for each producer neuron. Specifically, the electronics can adjust the range of each segment in consideration of the computable operation range of each producer neuron. Here, the sum of the ranges of the adjusted segments may differ from the given clipping range, and the boundary values for the ranges of the adjusted segments may not match. For example, in a case where the clipping range is divided into a first segment and a second segment, and the range of the first segment and the range of the second segment are respectively adjusted, the maximum value of the first adjusted segment range and the minimum value of the second adjusted segment range may not match. Each producer neuron outputs clipped activation according to each adjusted segment range.

To this end, the electronic device sets parameters of each producer neuron such that each producer neuron processes the input of the target producer neuron (S906).

The electronic device sets parameters of a consumer neuron connected to the target producer neuron such that the consumer neuron processes outputs of the plurality of producer neurons (S908).

According to an embodiment of the present disclosure, the parameters of each producer neuron can be set such that each producer neuron processes input using the same parameters as the parameters of the target producer neuron. Additionally, the parameters of the consumer neuron can be set such that the consumer neuron processes the outputs of the plurality of producer neurons using the same parameters as parameters applied to the output of the target producer and an offset according to the plurality of segments. Accordingly, the plurality of producer neurons and a consumer neuron connected to the plurality of producer neurons have the same parameters as the parameters of the target producer neuron and a consumer neuron connected to the target producer neuron. However, the plurality of producer neurons has different clipping ranges.

According to another embodiment of the present disclosure, the electronic device can adjust a plurality of segments for each producer neuron in consideration of the computable segment range of each producer neuron. The electronic device sets the parameters of each producer neuron based on the range of the segment corresponding to each producer neuron and the range of an adjusted segment. Additionally, the electronic device sets parameters applied to the output of each producer neuron based on the range of the segment corresponding to each producer neuron and the range of the adjusted segment. Accordingly, a plurality of producer neurons and a consumer neuron connected to the plurality of producer neurons have different parameters from the parameters of the target producer neuron and a consumer neuron connected to the target producer neuron. However, the plurality of producer neurons all have the same clipping range.

FIG. 10 is a configuration diagram of an electronic device according to an embodiment of the present disclosure.

Referring to FIG. 10, the electronic device 1000 may include some of all of a system memory 1010, a processor 1020, a storage 1030, an input/output interface 1040, and a communication interface 1050.

The system memory 1010 may store a program that allows the processor 1020 to perform a range determination method according to an embodiment of the present disclosure. For example, the program may include a plurality of instructions executable by the processor 1020, and the architecture of a neural network can be expanded by the processor 1020 executing the plurality of instructions.

The system memory 1010 may include at least one of a volatile memory and a nonvolatile memory. The volatile memory includes a static random access memory (SRAM) or a dynamic random access memory (DRAM), and the nonvolatile memory includes a flash memory.

The processor 1020 may include at least one core that can execute at least one instruction. The processor 1020 can execute the instructions stored in the system memory 1010.

The storage 1030 maintains the stored data even if power supplied to the electronic device 1000 is blocked. For example, the storage 1030 may include a nonvolatile memory such as an electrically erasable programmable read-only memory (EEPROM), a flash memory, a phase change random access memory (PRAM), a resistance random access memory (RRAM), or a nano floating gate memory (NFGM), or may include storage media such as a magnetic tape, an optical disc, and a magnetic disk. In some embodiments, the storage 1030 may be removed from the electronic device 1000.

According to an embodiment of the present disclosure, the storage 1030 may store a program for expanding the architecture of a neural network. The program stored in the storage 1030 may be loaded to the system memory 1010 before the program is executed by the processor 1020. The storage 1030 may store files written in a program language, and a program generated from a file by a compiler or the like may be loaded to the system memory 1010.

The storage 1030 may store data to be processed by the processor 1020 and data processed by the processor 1020.

The input/output interface 1040 may include an input device such as a keyboard, a mouse, and the like, and may include an output device such as a display device and a printer.

A user may trigger execution of the program by the processor 1020 through the input/output interface 1040. In addition, the user may set a target saturation rate through the input/output interface 1040.

The communication interface 1050 provides access to an external network. For example, the electronic device 1000 can communicate with other devices through the communication interface 1050.

Meanwhile, the electronic device 1000 may be a mobile computing device such as a laptop computer, or a smartphone as well as a stationary computing device such as a desktop computer, a server, or an AI accelerator.

An observer and a controller included in the electronic device 1000 may be a procedure as a set of a plurality of instructions executed by the processor and may be stored in a memory accessible by the processor.

Although FIG. 9 shows that process S900 to process S908 are sequentially performed, this is merely an example of the technical idea of an embodiment of the present disclosure. In other words, those skilled in the art can modify and apply the processes in various manners by changing the order shown in FIG. 9 or executing one or more of processes S900 to S908 in parallel without departing from the essential characteristics of an embodiment of the present disclosure, and thus FIG. 9 is not limited to a chronological order.

Meanwhile, the processes shown in FIG. 9 can be implemented as computer-readable code in a computer-readable recording medium. The computer-readable recording medium includes all kinds of recording devices that stores data readable by a computer system. That is, such computer-readable recording media include non-transitory media such as a ROM, a RAM, a CD-ROM, a magnetic tape, a floppy disk, and an optical data storage device. In addition, computer-readable record media can be distributed to computer systems connected via a network, and computer-readable code can be stored and executed in a distributed manner.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the present embodiments is not limited by the illustrations. Accordingly, one of ordinary skill would understand the scope of the claimed invention is not to be limited by the above explicitly described embodiments but by the claims and equivalents thereof.

This work was supported in part in Republic of Korea by the Ministry of Science, ICT & Future Planning (MSIP), (2020-0-01305, Developed a 2,000 TFLOPS server artificial intelligence deep learning processor and module).

### REFERENCE NUMERALS

1000: electronic device 1010: system memory
1020: processor 1030: storage
1040: input/output interface 1050: communication module)

### CROSS-REFERENCE TO RELATED APPLICATION

This application claims priority from Korean Patent Application No. 10-2021-0123351 filed on Sep. 15, 2021, the disclosures of which are incorporated by reference herein in their entireties.

1-10. (canceled)

11. A computer-implemented method for expanding an architecture of a neural network, the method comprising:
selecting a target producer neuron from neurons included in the neural network, the target producer neuron outputting an activation clipped according to a given clipping range;
dividing the given clipping range into a plurality of segments;
replacing the target producer neuron with a plurality of producer neurons corresponding to the segments;
setting parameters of each producer neuron such that each producer neuron processes an input of the target producer neuron; and
setting parameters of a consumer neuron connected to the target producer neuron such that the consumer neuron processes outputs of the plurality of producer neurons.

12. The method according to claim 11, wherein each producer neuron outputs an activation clipped according to a range of a corresponding segment among the plurality of segments.

13. The method according to claim 11, wherein a plurality of output activations output by the plurality of producer neurons has the same precision as precision of the clipped activation output by the target producer neuron.

14. The method according to claim 11, further comprising converting the plurality of segments into segments that have the same size as the given clipping range and do not overlap.

15. The method according to claim 11, wherein at least two of the plurality of segments have different sizes.

16. The method according to claim 11, further comprising adjusting the range of each segment in consideration of a computation range of each producer neuron.

17. The method according to claim 16, wherein the setting of parameters of each producer neuron comprises setting parameters of each producer neuron based on the range of the segment corresponding to each producer neuron and the adjusted range of the segment, and
the setting of parameters of the consumer neuron comprises setting parameters applied to the output of each producer neuron based on the range of the segment corresponding to each producer neuron and the adjusted range of the segment.

18. The method according to claim 11, wherein each producer neuron processes the input using the same parameters as parameters of the target producer neuron, and the consumer neuron processes the outputs of the plurality of producer neurons using the same parameters as parameters applied to the output of the target producer and an offset according to the plurality of segments.

19. A computing device comprising:
a memory in which instructions are stored; and
at least one processor,
wherein the at least one processor is configured to, by executing the instructions:
select a target producer neuron from the neurons included in a neural network, the target producer neuron outputting an activation clipped according to a given clipping range;
divide the given clipping range into a plurality of segments;
replace the target producer neuron with a plurality of producer neurons corresponding to the segments;
set parameters of each producer neuron such that each producer neuron processes an input of the target producer neuron; and
set parameters of a consumer neuron connected to the target producer neuron such that the consumer neuron processes outputs of the plurality of producer neurons.

20. A computer-readable recording medium recording a computer program for executing the method of claim 11.
